(19) United States
(12) Patent Application Publication
(10) Pub. No.: US 2026/0290910 A1
(43) Pub. Date: Sep. 24, 2026

(54) COMPOSITIONS FOR THE FORMATION OF BATTERY SHUTDOWN LAYERS

(71) Applicant: Dow Global Technologies LLC, Midland, MI (US)

(72) Inventors: Zheng Zhang, Shanghai (CN); Peng Gao, Shanghai (CN); Qiangqiang Yan, Zhejiang (CN); David L. Malotky, Midland, MI (US); Daniel Dermody, Midland, MI (US); Robert R. Bills, Midland, MI (US)

(21) Appl. No.: 19/477,531

(22) PCT Filed: May 25, 2023
(86) PCT No.: PCT/CN2023/096220

§ 371 Date: Oct. 22, 2025

(51) Int. Cl. H01M 10/42; C08L 23/06; C09K 5/06; H01M 50/42; H01M 50/489

(52) U.S. Cl. CPC H01M 10/4235; C08L 23/06; C09K 5/063; H01M 50/42; H01M 50/489; C08L 2201/50; C08L 2203/20; C08L 2205/025; C08L 2205/035

(57) ABSTRACT

A composition includes a polyolefin dispersion of one or more polyolefins having a melting point of 80° C. to 130° C. and having an average particle size of from 0.5 microns to 5 microns; and a healing dispersion comprising an ethylene methacrylic acid copolymer (“EMAA”) having a melting point of 80° C. to 120° C. and having an average particle size of from 0.1 microns to 1 micron, wherein the EMAA copolymer is from 0% to 40% neutralized, further wherein a weight ratio of the EMAA to polyolefin in the composition is from 1:100 to 10:100.

### BACKGROUND

### Field of the Invention

The present disclosure generally relates to compositions, and more specifically to ceramic compositions for the formation of shutdown layers.

### INTRODUCTION

Lithium-ion batteries (“LIBs”) offer a variety of advantages over traditional battery types such as high energy density, a high operating voltage and long cycle life. These advantages mean LIBs are widely used as a power supply for various mobile devices and electric vehicles. One of the key components of LIBs is a separator. The separator is typically made of a polyolefin based porous membrane that comprises high density polyethylene. The separator serves the function of separating the cathode from the anode to avoid the short circuit of the battery while permitting the passage of lithium ions during charging and discharging of the battery.

When LIBs exceed a critical temperature, exothermic chemical reactions are initiated, resulting in heat accumulation and internal pressure due to electrolyte evaporation which creates pin holes in the separator. The pin holes allow for unregulated lithium-ion transport causing increased temperature that results in thermal runaway. To prevent thermal runaway, the idea of a shutdown layer was introduced to LIBs separators. The shutdown layer is layer employing a phase change mechanism to stop ionic transportation when the separator temperature approaches onset of thermal runaway. The shutdown layer operates by melting to block the pin holes and diffusion channels of the separator thereby shutting down lithium-ion transportation. Despite being a promising idea, commercial progress has been slow because shutdown performance, measured as the difference between electrical resistance of the LIB before and after phase change of the shutdown layer, remains too low to effectively mitigate thermal run away. In order to adequately resist thermal runaway, LIBs including a shutdown layer should have a shutdown performance of 50 ohms or better.

Copolymers of ethylene and methacrylic acid (“EMAA”) are known to exhibit self-healing properties when physical damage is inflicted on it. The greater the methacrylic acid component of the EMAA copolymers that is neutralized, the greater the ionic content of the EMAA copolymer. With respect to the self-healing properties of EMAA, the paper Effect of Ionic Content on Ballistic Self-Healing in EMAA Copolymers and Ionomers explains that “[m]oderate ionic content proved the most beneficial to healing for tests below the order-disorder transition (Tᵢ=40° C.); while above and into the melt (Tₘ=90° C.) healing improved with increasing ionic content. (Polym. Chem., 2013, 4, 4910 at Abstract). In essence, the greater the neutralization of methacrylic acid in the EMAA, the greater the self-healing effect observed at higher temperatures. While the self-healing properties of EMAA in air and gaseous environments are understood, the ability of EMAA to maintain its self-healing properties in the presence of solvents and electrolytes is unknown and not expected to persist due to the lack of other forces present (e.g., surface tension, etc.) that would exist in air and gaseous environments.

In view of the foregoing, it would be surprising to discover a shutdown layer, and compositions that can form the shutdown layer, that exhibits a shutdown performance of 50 ohms or greater in the presence of battery electrolytes but also comprises low or non-neutralized EMAA to provide self-healing properties in the shutdown layer.

### SUMMARY OF THE DISCLOSURE

The inventors of the present disclosure have discovered a shutdown layer, and compositions that can form the shutdown layer, that exhibits a shutdown performance of 50 ohms or greater in the presence of battery electrolytes but also comprises low or non-neutralized EMAA to provide self-healing properties in the shutdown layer.

The invention is the result of surprisingly discovering that low or non-neutralized EMAA can be used to form shutdown layers that maintain self-healing properties despite being in contact with battery electrolytes. Without being bound by theory, it is believed that because the EMAA is surface active it will be present at the interface between the electrolyte and the polyolefin. As the polyolefin melts and coalesces into a continuous coating when the LIB is approaching thermal runaway, the amount of electrolyte-olefin interface decreases dramatically. With the decrease in electrolyte-olefin interface, the EMAA is concentrated in locations where the olefin has not formed a continuous film, plugging holes and thereby “healing” defects in the coating. With the defects in the coating sealed, the shutdown layer is able to effectively prevent thermal runaway. Such a discovery is surprising as the above-noted paper highlights that increasing ionic content it preferred at temperatures at or above melting (90° C.), yet EMAA with low or no neutralization is able to effectively heal itself at these temperatures when utilized as a shutdown layer in LIBs.

According to a first feature of the present disclosure, a composition comprises a polyolefin dispersion of one or more polyolefins having a melting point of 80° C. to 130° C. and having an average particle size of from 0.5 microns to 5 microns; and a healing dispersion comprising an ethylene methacrylic acid copolymer (“EMAA”) having a melting point of 80° C. to 120° C. and having an average particle size of from 0.1 microns to 1 micron, wherein the EMAA copolymer is from 0% to 40% neutralized, further wherein a weight ratio of the EMAA to polyolefin in the composition is from 1:100 to 10:100.

According to a second feature of the present disclosure, the polyolefin and the EMAA are each dispersed in water.

According to a third feature of the present disclosure, the healing dispersion is from 5 wt % to 40 wt % solids based on the total weight of the healing dispersion and the polyolefin dispersion is from 30 wt % to 70 wt % solids based on the total weight of the polyolefin dispersion.

According to a fourth feature of the present disclosure, the polyolefin is selected from the group consisting of ethylene, an ethylene-propylene copolymer, an ethylene-butylene copolymer, an ethylene-hexene copolymer, and ethylene-octene copolymer.

According to a fifth feature of the present disclosure, the polyolefin exhibits a melting temperature of 100° C. to 120° C.

According to a sixth feature of the present disclosure, the weight ratio the EMAA to polyolefin in the composition is from 3:100 to 5:100.

According to a seventh feature of the present disclosure, the polyolefin exhibits a melting temperature of 100° C. to 110° C.

According to an eighth feature of the present disclosure, the EMAA comprises from 4 wt % to 20 wt % methacrylic acid based on the total weight of the EMAA.

According to a ninth feature of the present disclosure, the EMAA copolymer is from 20% to 40% neutralized.

According to a tenth feature of the present disclosure, a shutdown composition, comprises the composition, a binder, a wetting agent; and a thickener.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, unless otherwise indicated, the term “average particle size” means a volume mean particle size, as determined using a Coulter LS 13 320 particle size analyzer (Beckman Coulter, Brea, Calif.) per manufacturer's recommended procedures via laser scattering).

As used herein, the term “Melt index” means the value determined according to ASTM D-1238 (2013). Melt index values are defined as the amount of polymer melt passing in dg/min (or g/10 min) through a heated syringe with a plunger load at 190° C. and 2.16 kg load for polyethylene polymer and at 230° C. and 2.16 kg load for polypropylene polymer. For olefin copolymers, the polypropylene melt index test will be used if more than 50 wt. % of the copolymer comprises propylene in polymerized form. As used herein, the term “melting point” means the value determined by DSC method using a ramp rate of from 10° C./min.

As used herein, the term “solids” refers to the wt. % in compositions of solids of the primary polyolefin dispersions, the second film forming dispersion, dispersants, and stabilizing agents and, when present, pigments, fillers or extenders and any additives that are not volatile under use conditions for the compositions of the present invention. For example, water, additives such as coalescents and solvents or bases, like ammonia or lower alkyl amines that volatilize under use conditions of the compositions of the present invention are not considered solids.

### Composition

The present disclosure is directed to a composition. The composition comprises a polyolefin dispersion and a healing dispersion. The composition may be used in the formation of a shutdown composition.

### Polyolefin Dispersion

The polyolefin dispersion is a plurality of polyolefin particles dispersed in a carrier fluid (e.g., water). The polyolefin may comprise ethylene, propylene, butylene, hexene, octene and/or combinations thereof. For example, the polyolefin may be selected from the group consisting of ethylene, an ethylene-propylene copolymer, an ethylene-butylene copolymer, an ethylene-hexene copolymer, and ethylene-octene copolymer. The polyolefin exhibits a melting temperature of 100° C. to 120° C. For example, the polyolefin may exhibit a melting temperature of 80° C. or greater, or 85° C. or greater, or 90° C. or greater, or 95° C. or greater, or 100° C. or greater, or 105° C. or greater, or 110° C. or greater, or 115° C. or greater, or 120° C. or greater, or 125° C. or greater, while at the same time, 130° C. or less, or 125° C. or less, or 120° C. or less, or 115° C. or less, or 110° C. or less, or 105° C. or less, or 100° C. or less, or 95° C. or less, or 90° C. or less, or 85° C. or less.

The polyolefin particles of the polyolefin dispersion have an average particle size of from 0.5 microns to 5 microns. For example, the polyolefin particles of the polyolefin dispersion may have an average particle size of 0.5 microns or greater, or 1.0 microns or greater, or 1.5 microns or greater, or 2.0 microns or greater, or 2.5 microns or greater, or 3.0 microns or greater, or 3.5 microns or greater, or 4.0 microns or greater, or 4.5 microns or greater, while at the same time, 5.0 microns or less, or 4.5 microns or less, or 4.0 microns or less, or 3.5 microns or less, or 3.0 microns or less, or 2.5 microns or less, or 2.0 microns or less, or 1.5 microns or less, or 1.0 microns or less.

The polyolefin dispersion may be from 30 wt % to 70 wt % solids based on the total weight of the polyolefin dispersion. For example, the polyolefin dispersion may be from 30 wt % or greater, or 35 wt % or greater, or 40 wt % or greater, or 45 wt % or greater, or 50 wt % or greater, or 55 wt % or greater, or 60 wt % or greater, or 65 wt % or greater, while at the same time, 70 wt % or less, or 65 wt % or less, or 60 wt % or less, or 55 wt % or less, or 50 wt % or less, or 45 wt % or less, or 40 wt % or less, or 35 wt % or less solids based on the total weight of the polyolefin dispersion.

A dispersing agent may be used to make the polyolefin dispersion. The dispersing agent can be a long chain fatty acid having from 14 to 40 carbon atoms or, preferably, from 16 to 36 carbon atoms, such as a Unicid™ 350 dispersing agent or behenic (C₂₂) acid. The dispersing agent may be present in an amount of 10 wt % or less, or 6 wt % or less, or 4 wt % or less based on the total weight of the polyolefin dispersion.

### Healing Dispersion

The healing dispersion is a plurality of EMAA particles dispersed or emulsified in a carrier fluid (e.g., water). The EMAA comprises from 4 wt % to 20 wt % of units derived from methacrylic acid based on the total weight of the EMAA. For example, the EMAA comprises 4 wt % or greater, or 5 wt % or greater, or 6 wt % or greater, or 7 wt % or greater, or 8 wt % or greater, or 10 wt % or greater, or 12 wt % or greater, or 14 wt % or greater, or 15 wt % or greater, or 16 wt % or greater, or 18 wt % or greater, while at the same time, 20 wt % or less, or 18 wt % or less, or 16 wt % or less, or 15 wt % or less, or 14 wt % or less, or 12 wt % or less, or 10 wt % or less, or 8 wt % or less, or 7 wt % or less, or 6 wt % or less of units derived from methacrylic acid based on the total weight of the EMAA. The balance of the EMAA comprises units derived from ethylene.

The EMAA exhibits a melting temperature of 80° C. to 120° C. For example, the EMAA may exhibit a melting temperature of 80° C. or greater, or 85° C. or greater, or 90° C. or greater, or 95° C. or greater, or 100° C. or greater, or 105° C. or greater, or 110° C. or greater, or 115° C. or greater, or 120° C. or greater, or 125° C. or greater, while at the same time, 130° C. or less, or 125° C. or less, or 120° C. or less, or 115° C. or less, or 110° C. or less, or 105° C. or less, or 100° C. or less, or 95° C. or less, or 90° C. or less, or 85° C. or less.

The EMAA particles of the healing dispersion have an average particle size from 0.1 microns to 1 micron. For example, the polyolefin particles of the polyolefin dispersion may have an average particle size of 0.1 microns or greater, or 0.2 microns or greater, or 0.3 microns or greater, or 0.4 microns or greater, or 0.5 microns or greater, or 0.6 microns or greater, or 0.7 microns or greater, or 0.8 microns or greater, or 0.9 microns or greater, while at the same time, 1.0 micron or less, or 0.9 microns or less, or 0.8 microns or less, or 0.7 microns or less, or 0.6 microns or less, or 0.5 microns or less, or 0.4 microns or less, or 0.3 microns or less, or 0.2 microns or less.

The healing dispersion may be from 5 wt % to 40 wt % solids based on the total weight of the polyolefin dispersion. For example, the polyolefin dispersion may be from 5 wt % or greater, or 10 wt % or greater, or 15 wt % or greater, or 20 wt % or greater, or 25 wt % or greater, or 30 wt % or greater, or 35 wt % or greater, while at the same time, 40 wt % or less, or 35 wt % or less, or 30 wt % or less, or 25 wt % or less, or 20 wt % or less, or 15 wt % or less, or 10 wt % or less solids based on the total weight of the healing dispersion.

The EMAA may have a wide degree of neutralization. For example, the EMAA can be neutralized at 0% or greater, or 1% or greater, or 2% or greater, or 4% or greater, or 6% or greater, or 8% or greater, or 10% or greater, or 12% or greater, or 14% or greater, or 16% or greater, or 18% or greater, or 20% or greater, or 22% or greater, or 24% or greater, or 26% or greater, or 28% or greater, or 30% or greater, or 32% or greater, or 34% or greater, or 36% or greater, or 38% or greater, while at the same time, 40% or less, or 38% or less, or 36% or less, or 34% or less, or 32% or less, or 30% or less, or 28% or less, or 26% or less, or 24% or less, or 22% or less, or 20% or less, or 18% or less, or 16% or less, or 14% or less, or 12% or less, or 10% or less, or 8% or less, or 6% or less, or 4% or less, or 2% or less based on the total acid content. The EMAA may be neutralized using one or more metallic ions. The metallic ions can be monovalent, divalent, trivalent, multivalent, or combinations thereof. Examples of suitable metallic ions include Li, Na, Ag, Hg, Cu, Be, Mg, Ca, Sr, Ba, Cd, Sn, Pb, Fe, Co, Zn, Ni, Al, Sc, Hf, Ti, Zr, Ce, K, Na, and combinations thereof. If the metallic ion is multivalent, a complexing agent, such as stearate, oleate, salicylate, and phenolate radicals can be included. The EMAA can be a blend of an EMAA having a greater than 30% neutralization and, for example, a second EMAA having a lower neutralization to achieve the desired degree of neutralization.

The EMAA may be present in the healing dispersion at such a concentration that a weight ratio of the EMAA to polyolefin in the composition is from 1:100 to 10:100. For example, the weight ratio of EMAA to polyolefin in the composition may be 1:100 or greater, or 2:100 or greater, or 3:100 or greater, or 4:100 or greater, or 5:100 or greater, or 6:100 or greater, or 7:100 or greater, or 8:100 or greater, or 9:100 or greater, while at the same time, 10:100 or less, or 9:100 or less, or 8:100 or less, or 7:100 or less, or 6:100 or less, or 5:100 or less, or 4:100 or less, or 3:100 or less, or 2:100 or less.

### Shutdown Composition

As stated above, the present disclosure is also directed to a shutdown composition which can comprise the composition, a binder, a wetting agent, and a thickener.

The thickener functions to thicken the shutdown composition such that it can be applied, and adhere well, to the battery separator. The shutdown composition may comprise from 0.01 wt % to 1.00 wt % of the thickener based on the total weight of the shutdown composition. For example, the shutdown composition may comprise 0.01 wt % or greater, or 0.05 wt % or greater, or 0.10 wt % or greater, or 0.15 wt % or greater, or 0.20 wt % or greater, or 0.25 wt % or greater, or 0.30 wt % or greater, or 0.35 wt % or greater, or 0.40 wt % or greater, or 0.45 wt % or greater, or 0.50 wt % or greater, or 0.55 wt % or greater, or 0.60 wt % or greater, or 0.65 wt % or greater, or 0.70 wt % or greater, or 0.75 wt % or greater, or 0.80 wt % or greater, or 0.85 wt % or greater, or 0.90 wt % or greater, or 0.95 wt % or greater, while at the same time, 1.00 wt % or less, or 0.95 wt % or less, or 0.90 wt % or less, or 0.85 wt % or less, or 0.80 wt % or less, or 0.75 wt % or less, or 0.70 wt % or less, or 0.65 wt % or less, or 0.60 wt % or less, or 0.55 wt % or less, or 0.50 wt % or less, or 0.45 wt % or less, or 0.40 wt % or less, or 0.35 wt % or less, or 0.30 wt % or less, or 0.25 wt % or less, or 0.20 wt % or less, or 0.15 wt % or less, or 0.10 wt % or less, or 0.05 wt % or less of thickener based on the total weight of the shutdown composition.

The thickener is a copolymer of units derived from ethyl acrylate, meth acrylic acid and a functional monomer. The thickener may be a random copolymer or a block copolymer. The thickener may be added to the shutdown composition as a dispersion of the thickener in one or more fluids (e.g., water). The thickener may be from 5 wt % to 50 wt % solids based on the total weight of the thickener. For example, the thickener may be may be 5 wt % or greater, or 10 wt % or greater, or 15 wt % or greater, 20 wt % or greater, or 25 wt % or greater, or 30 wt % or greater, or 35 wt % or greater, or 40 wt % or greater, or 45 wt % or greater, while at the same time, 50 wt % or less, or 45 wt % or less, or 40 wt % or less, or 35 wt % or less, or 30 wt % or less, or 25 wt % or less, or 20 wt % or less, or 15 wt % or less, or 10 wt % or less solids based on a total weight of the thickener.

The thickener comprises from 30 wt % to 70 wt % of units derived from ethyl acrylate based on a total weight of the thickener. For example, the thickener may be may be 30 wt % or greater, or 35 wt % or greater, or 40 wt % or greater, or 45 wt % or greater, or 50 wt % or greater, or 55 wt % or greater, or 60 wt % or greater, or 65 wt % or greater, while at the same time, 70 wt % or less, or 65 wt % or less, or 60 wt % or less, or 55 wt % or less, or 50 wt % or less, or 45 wt % or less, or 40 wt % or less, or 35 wt % or less ethyl acrylate based on a total weight of the thickener.

The thickener comprises from 20 wt % to 60 wt % of units derived from meth acrylic acid based on a total weight of the thickener. For example, the thickener may be may be 20 wt % or greater, or 25 wt % or greater, or 30 wt % or greater, or 35 wt % or greater, or 40 wt % or greater, or 45 wt % or greater, or 50 wt % or greater, or 55 wt % or greater, while at the same time, 60 wt % or less, or 55 wt % or less, or 50 wt % or less, or 45 wt % or less, or 40 wt % or less, or 35 wt % or less, or 30 wt % or less, or 25 wt % or less of units derived from meth acrylic acid based on a total weight of the thickener.

The thickener comprises units derived from the functional monomer. The functional monomer has Structure (I)

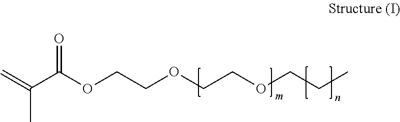

wherein m is an average value from 10 to 40 and n has an average value from 5 to 30. The m and n values of Structure (I) are determined using ¹³C Nuclear Magnetic Resonance. The m of Structure (I) may have an average value of 10 or greater, or 12 or greater, or 14 or greater, or 16 or greater, or 18 or greater, or 20 or greater, or 22 or greater, or 24 or greater, or 26 or greater, or 28 or greater, or 30 or greater, or 32 or greater, or 34 or greater, or 36 or greater, or 38 or greater, while at the same time, 40 or less, or 38 or less, or 36 or less, or 34 or less, or 32 or less, or 30 or less, or 28 or less, or 26 or less, or 24 or less, or 22 or less, or 20 or less, or 18 or less, or 16 or less, or 14 or less, or 12 or less. The n of Structure (I) may have an average value of 5 or greater, or 6 or greater, or 8 or greater, or 10 or greater, or 12 or greater, or 14 or greater, or 16 or greater, or 18 or greater, or 20 or greater, or 22 or greater, or 24 or greater, or 26 or greater, or 28 or greater, while at the same time, 30 or less, or 28 or less, or 26 or less, or 24 or less, or 22 or less, or 20 or less, or 18 or less, or 16 or less, or 14 or less, or 12 or less, or 10 or less, or 8 or less, or 6 or less.

The thickener may comprise from 1 wt % to 20 wt % of the functional monomer based on the total weight of the thickener. For example, thickener may comprise 1 wt % or greater, or 2 wt % or greater, or 4 wt % or greater, or 6 wt % or greater, or 8 wt % or greater, or 10 wt % or greater, or 12 wt % or greater, or 14 wt % or greater, or 16 wt % or greater, or 18 wt % or greater, while at the same time, 20 wt % or less, or 18 wt % or less, or 16 wt % or less, or 14 wt % or less, or 12 wt % or less, or 10 wt % or less, or 8 wt % or less, or 6 wt % or less, or 4 wt % or less, or 2 wt % or less of the functional monomer based on the total weight of the thickener.

The thickener may be added to the shutdown composition as a thickener solution with the thickener dissolved in a solvent to form a thickener solution. The solvent in which the thickener is dissolved may be water or another solvent. Lithium hydroxide may be added to the thickener solution to bring the pH of the solution to a desired value. The pH of the thickener solution may be 7.0 or greater, or 7.2 or greater, or 7.4 or greater, or 7.6 or greater, or 7.8 or greater, or 8.0 or greater, or 8.1 or greater, or 8.2 or greater, or 8.4 or greater, or 8.6 or greater or 8.8 or greater, while at the same time, 9.0 or less, or 8.8 or less, or 8.6 or less, or 8.4 or less, or 8.2 or less, or 8.0 or less, or 7.8 or less, or 7.6 or less, or 7.4 or less, or 7.2 or less.

The shutdown composition comprises the binder. The binder aids in binding the materials of the shutdown composition together once they are deposited on a separator and after the shutdown composition has been dried to form the shutdown layer. The binder may comprise one or more of polybutylacrylate and styrene-butadiene rubber.

The shutdown composition may comprise from 0.1 wt % to 7 wt % of the binder based on the total weight of the shutdown composition. For example, the shutdown composition may comprise 0.1 wt % or greater, or 0.5 wt % or greater, or 1 wt % or greater, or 2 wt % or greater, or 3 wt % or greater, or 4 wt % or greater, or 5 wt % or greater, or 6 wt % or greater, while at the same time, 7 wt % or less, or 6 wt % or less, or 5 wt % or less, or 4 wt % or less, or 3 wt % or less, or 2 wt % or less, or 1 wt % or less, or 0.5 wt % or less of the binder based on the total weight of the shutdown composition.

The binder may be added to the shutdown composition a solid or as an emulsion. In examples where the binder is an emulsion, the binder emulsion may be from 20 wt % to 60 wt % solids based on the total weight of the binder emulsion. For example, the binder emulsion may be 20 wt % or greater, or 25 wt % or greater, or 30 wt % or greater, or 35 wt % or greater, or 40 wt % or greater, or 45 wt % or greater, or 50 wt % or greater, or 55 wt % or greater, while at the same time, 60 wt % or less, or 55 wt % or less, or 50 wt % or less, or 45 wt % or less, or 40 wt % or less, or 35 wt % or less, or 30 wt % or less, or 25 wt % or less based on a total weight of the binder emulsion. In examples where the binder is added as a binder emulsion to the shutdown composition, the shutdown composition may comprise from 1 wt % to 10 wt % of the binder emulsion based on the total weight of the shutdown composition. For example, the shutdown composition may comprise 1 wt % or greater, or 2 wt % or greater, or 3 wt % or greater, or 4 wt % or greater, or 5 wt % or greater, or 6 wt % or greater, or 7 wt % or greater, or 8 wt % or greater, or 9 wt % or greater, while at the same time, 10 wt % or less, or 9 wt % or less, or 8 wt % or less, or 7 wt % or less, or 6 wt % or less, or 5 wt % or less, or 4 wt % or less, or 3 wt % or less, or 2 wt % or less of the binder emulsion based on the total weight of the shutdown composition.

The shutdown composition may comprise one or more additive or auxiliary polymers, such as one or more of an acrylic emulsion polymer, vinyl acrylic emulsion polymer, styrene acrylic emulsion polymer, vinyl acetate ethylene emulsion polymer, and combinations thereof; one or more fillers; one or more additives such as catalysts, wetting agents, defoamers, flow agents, release agents, slip agents, anti-blocking agents, additives to mask sulfur staining, pigment wetting/dispersion agents, anti-settling agents, one or more co-solvents, e.g., glycols, glycol ether, 2,2,4-trimethyl-1,3-pentanediol monoisobutyrate, alcohols, mineral spirits, aromatic solvents and benzoate esters or the like; one or more dispersants, e.g., aminoalcohols, and polycarboxylates; one or more surfactants; one or more preservatives, e.g., biocides, mildewcides, fungicides, algaecides, and combinations thereof; or one or more additional neutralizing agents, e.g., hydroxides, amines, ammonia, and carbonates; optionally one or more solvents or coalescing agents. In a specific example, the shutdown composition may comprise a highly branched secondary alcohol ethoxylate surfactant in an amount ranging from 0.1 wt % to 1 wt %, or from 0.2 wt % to 0.8 wt %, or from 0.3 wt % to 0.5 wt % based on the total weight of the shutdown composition. A commercial example of a highly branched secondary alcohol ethoxylate surfactant is TRITON™ HW-1000 from The Dow Chemical Company, Midland Michigan. In another specific example, the shutdown composition may comprise a highly branched secondary alcohol ethoxylate surfactant in an amount ranging from 0.05 wt % to 1 wt %, or from 0.1 wt % to 0.5 wt %, or from 0.15 wt % to 0.3 wt % based on the total weight of the shutdown composition.

The shutdown composition may be applied to the substrates (e.g., separators) by a variety of methods; for example, via roller coating, spray coating, powder coating, dip coating, electro deposition coating, printing, wash coating, flow coating, curtain coating to form the shutdown layer. The thicknesses of the shutdown layer can range from 1 micrometer (μm) to 25 μm. For example, the thickness of the shutdown layer may be 1 μm or greater, or 2 μm or greater, or 3 μm or greater, or 4 μm or greater, or 5 μm or greater, or 10 μm or greater, or 15 μm or greater, or 20 μm or greater, while at the same time, 25 μm or less, or 20 μm or less, or 15 μm or less, or 10 μm or less, or 5 μm or less, or 4 μm or less, or 3 μm or less, or 2 μm or less.

The shutdown composition, once applied to the separator, may be dried via a conventional drying method to form the shutdown layer. Such a conventional drying method includes but is not limited to, air drying, convection oven drying, hot air drying, and/or infrared oven drying.

### EXAMPLES

### Materials

The following materials were used in the formation of the comparative examples (“CE”) and the inventive examples (“IE”).

Polyethylene is polyethylene resin having a density of 0.91 g/cc, a melt index (190° C./2.16 kg) of 15 g/10 minute and is commercially available as Dow ELITE™ 5815 from The Dow Chemical Company, Midland, MI.

EMAA is ethylene-methacrylic acid having a methacrylic acid content of 15 wt %, a density of 0.94 g/cc, a melt index (190° C./2.16 kg) of 60 g/10 min. has a 0% neutralization and is commercially available as Dow NUCREL™ 960, from The Dow Chemical Company, Midland, MI.

The aliphatic acid used has greater than 18 carbon number, a melting point of 80° C., an acid number (mg KOH/g sample) of 135~160 and is commercially available under the tradename WARADUR™ Montan wax from Voelpker. Co., Völpke, Germany.

KOH is analytical grade potassium hydroxide which is available from Sinopharm Chemical Reagent Co., Shanghai, China.

SBR is styrene-butadiene-rubber latex binder which is commercially available as BM-451B Zeon Corp. Tokyo, Japan.

Thickener solution is a 1.5 wt % a copolymer (an EA, MAA and functional monomer copolymer comprising 49.9 wt % EA, 39.9 wt % MAA and 10.2 wt % of Structure (I) where m has an average value of 20 and n has an average value of 16 to 18) in water based on the total weight of the thickener solution that is neutralized to a pH of about 8 using LiOH.

WA is a highly branched wetting agent commercially available as TRITON™ HW-1000 from The Dow Chemical Company, Midland, Michigan, USA

HDPE is a 12 μm thick high density polyethylene separator available from Shenzhen Senior Technology Material Co., Ltd., Shenzhen, China.

The Cathode materials were Ni—Co—Mn (NCM) S740B, purchased from Rongbai company, Yuyao, China.

The anode materials were graphite FSN-1, purchased from Shanshan company, Shanghai, China

The electrolyte was a mixture of carbonate solvent and LiPF6 by ratio of 9:1, purchased from Guangzhou Tianci company, Guangdong, China

### Sample Preparation

### Shutdown Coating Preparation and Application

A polyolefin dispersion was created loading the polyethylene and aliphatic acid into special designed twin screw extruder (“TSE”) with a back pressure of around 2 megapascals (“MPa”). The polyethylene and dispersant (83.33 g/min HDPE DMDA8965 and 4.58 g/min montanic acid) was melted and blended with injected KOH solution (30% wt. 1.74 ml/min, 100% degree of neutralization of montanic acid) and small volume initial water (1.9 ml/min) in the TSE at a temperature of 160° C. and 400 revolutions per minute (“rpm”) screw rotation. A high internal phase emulsion (HIPE) was formed during this process and then diluted with water (120 ml/min) to approximately 50 wt % solids. After the dispersion had cooled to below 100° C., a 50 wt % solids polyolefin dispersion with a particle size of 0.7~1 μm was collected.

An EMAA dispersion was prepared by loading the EMAA into the TSE at a rate of 33.33 g/min with a back pressure of around 2 MPa. The TSE was operated at a temperature of 150° C. and 500 rpm screw rotation. EMAA was melted and blended with injected KOH solution (30% wt., 2.61 ml/min, resulting in the EMAA dispersion having a 31% degree of neutralization) and small volume initial water (14.3 ml/min) in the TSE at a temperature of 150° C. and 500 rpm screw rotation. A high internal phase emulsion (HIPE) was formed during this process and then diluted with water (120 ml/min) to approximately 20 wt %. After the emulsion was cooled to below 100° C., a 20 wt % solids EMAA dispersion with particle size of 0.2~0.3 μm was collected.

The shutdown dispersion was formulated with the composition depicted in Table 1 following the adding sequence of polyolefin dispersion, EMAA dispersion, thickener, binder, and water. The formulation was prepared in a 150 ml plastic vial with cap and mixed at 1500 rpm for 5 minutes in a SpeedMixer DAC 150 mixer.

TABLE 1

| Components | CE | IE1 | IE2 | IE3 |
|---|---|---|---|---|
| Polyolefin dispersion | 20.000 | 20.000 | 20.000 | 20.000 |
| EMAA dispersion | | 2.031 | 1.523 | 2.539 |
| SBR | 0.555 | 0.570 | 0.565 | 1.480 |
| Thickener solution | 0.500 | 0.5 | 0.5 | 0.1 |
| WA | 0.150 | 0.15 | 0.15 | 0.15 |
| H₂O | 1.750 | 0.35 | 0.65 | 0.23 |
| Total | 22.955 | 23.60 | 23.39 | 24.50 |
| Solids: | 50.0% | 50.0% | 50.0% | 50.0% |

### Lithium-Ion Battery Assembly

A replica 100 milliamp hour capacity pouch cell type LIB was chosen to evaluate thermo-response performance. The cathode, separator and anode were stacked manually, and then put into plastic-aluminum bag. Connectors were attached on the cathode and anode separately. This sample was moved to vacuum oven for dehydration at 80° C. for 24 hours. 2 milliliters of electrolyte was injected, then the plastic-aluminum bag was sealed by a hot compression machine. The battery was attached to a Landian battery charging-discharging equipment to run battery formation process to initiate the battery.

### Test Methods

Thermo-response performance test: The Lithium-ion battery samples were tested for electrical resistance using a Hioki Battery HiTester BT 3562 before and after being placed in a 115° C. oven.

Calculation of Degree of Neutralization: The degree of neutralization (“DoN”) of the EMAA in the healing dispersion is determined by the following equation:

$$D o N = \frac{56000 \times W}{{E}_{B} {\sum }_{i} {A}_{i} {ω}_{i}} \times 100$$

where W is the weight of the base added in g, E_{B} is the equivalent weight of the base, Aᵢ is the acid number of the i^{th} component in units of mg KOH/g and the ωᵢ is the weight fraction of the ith component in EMAA of the healing dispersion.

### Results

The results of the thermo-response performance test are provided in Table 2.

TABLE 2

| | Resistance Before | Resistance After |
|---|---|---|
| Sample | Heat (Ohms) | Heat (Ohms) |
| CE1 | 0.375 | 27.9 |
| IE1 | 0.476 | 178.0 |
| IE2 | 0.379 | 127.6 |
| IE3 | 0.602 | 257.0 |

Referring now to Table 2, it is clear from CE1 and IE1-IE3 that the introduction of the shutdown layer made from the composition is able to effectively shut down lithium-ion transport in the battery as demonstrated by the great increase in resistance despite there being no significant difference in resistance of the samples before heating. CE1 demonstrates that the lack of EMAA in the formation of the shutdown layer produces after heat resistances a fraction of what was provided by the EMAA containing IE1-IE3. Such a result is indicative of defects and holes not being effectively sealed. IE1 demonstrates that the inclusion of EMAA into the composition decreased Li ion transportation during heating thereby creating an effective shutdown layer. IE2 and IE3 exhibited electric resistance increases after heating to 127.6 ohms and 257 ohms separately, which indicates EMAA content influence electric resistance, higher EMAA content, higher electric resistance during heating.

What is claimed is:

1. A composition, comprising
a polyolefin dispersion of one or more polyolefins having a melting point of 80° C. to 130° C. and having an average particle size of from 0.5 microns to 5 microns; and
a healing dispersion comprising an ethylene methacrylic acid copolymer (“EMAA”) having a melting point of 80° C. to 120° C. and having an average particle size of from 0.1 microns to 1 micron, wherein the EMAA copolymer is from 0% to 40% neutralized,
further wherein a weight ratio of the EMAA to polyolefin in the composition is from 1:100 to 10:100.

2. The composition of claim 1, wherein the polyolefin and the EMAA are each dispersed in water.

3. The composition of one of claims 1 and 2, wherein the healing dispersion is from 5 wt % to 40 wt % solids based on the total weight of the healing dispersion and the polyolefin dispersion is from 30 wt % to 70 wt % solids based on the total weight of the polyolefin dispersion.

4. The composition of any one of claims 1-3, wherein the polyolefin is selected from the group consisting of ethylene, an ethylene-propylene copolymer, an ethylene-butylene copolymer, an ethylene-hexene copolymer, and ethylene-octene copolymer.

5. The composition of any one of claims 1-4, wherein the polyolefin exhibits a melting temperature of 100° C. to 120° C.

6. The composition of any one of claims 1-5, wherein the weight ratio the EMAA to polyolefin in the composition is from 3:100 to 5:100.

7. The composition of any one of claims 1-6, wherein the polyolefin exhibits a melting temperature of 100° C. to 110° C.

8. The composition of any one of claims 1-7, wherein the EMAA comprises from 4 wt % to 20 wt % methacrylic acid based on the total weight of the EMAA.

9. The composition of claim 8, wherein the EMAA copolymer is from 20% to 40% neutralized.

10. A shutdown composition, comprising:
a composition comprising a polyolefin dispersion of one or more polyolefins having a melting point of 80° C. to 130° C. and having an average particle size of from 0.5 microns to 5 microns; and
a healing dispersion comprising an ethylene methacrylic acid copolymer (“EMAA”) having a melting point of 80° C. to 120° C. and having an average particle size of from 0.1 microns to 1 micron, wherein the EMAA copolymer is from 0% to 40% neutralized,
further wherein a weight ratio of the EMAA to polyolefin in the composition is from 1:100 to 10:100
the composition of any of claims 1-9;
a binder;
a wetting agent; and
a thickener.
